(19) United States
(12) Patent Application Publication
(10) Pub. No.: US 2006/0217163 A1
(43) Pub. Date: Sep. 28, 2006

(54) Cradle for portable device

(75) Inventor: Toshiyuki Ohmori, Saitama-ken (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/377,280

(22) Filed: Mar. 17, 2006

(30) Foreign Application Priority Data
Mar. 22, 2005 (JP) 2005-081948

(51) Int. Cl. H04B 1/38; H04M 1/00

(52) U.S. Cl. 455/575.1; 455/90.3

(57) ABSTRACT

A portable cradle for housing a portable device therein is provided. The portable cradle for the portable device having at least one device-side terminal and a display panel for displaying images includes a housing portion, which houses therein the portable device with the display panel, the display panel being exposed from the housing portion, and covers the at least one device-side terminal when the portable device is inserted from one side of the housing portion, and a foldable base portion, which is provided at a side of the housing portion opposite of the side from which the portable device is inserted. The portable device housed in the cradle is supported by the base portion in an inclined position with the display panel facing in a predetermined direction. The housing portion includes at least one cradle-side terminal, the at least one cradle-side terminal being adapted to be connected to the at least one device-side terminal of the portable device. An internal circuit of the portable device is connected to an external device via the at least one cradle-side terminal and the at least one device-side terminal connected to the at least one cradle-side terminal.

### BACKGROUND OF THE INVENTION

The present invention relates to a cradle for a portable device, and particularly to a cradle itself being portable, in which the portable device is held and is enabled to achieve a plurality of functions, including a function to charge a battery of the portable device being connected to an external power source, and a function to provide an interface with an external device such as a personal computer to exchange data therebetween.

In many cases, a cradle for a portable device such as a digital camera and a PDA (personal digital assistance) is settled on top of a flat surface, for example a desktop. When the portable device is adapted to be held in the cradle, the cradle is designed to be substantially larger in size than the device body. In another cases, a cradle is designed to be in a foldable configuration for portability of the cradle itself. An example of such a cradle is disclosed in Japanese Patent Provisional Publication No. 2003-110677. The cradle in the publication is configured to have an attachment portion, in which a PDA is placed, and a base portion, which is in contact with a desktop when settled, and the attachment portion and the base portion are hinged to be angularly movable with respect to each other. By rotating the base portion with respect to the attachment portion so that the base portion comes into contact with the attachment portion, the cradle is folded at the hinge in two, and thereby the cradle becomes compact and portability thereof improves.

The cradle in the above-referenced publication, however, is configured to cover only a lower portion of the PDA. In addition, the cradle lacks a holding mechanism that prevents the device from being unintentionally separated from the cradle. Therefore, although the cradle itself may be carried in a compact configuration, the cradle along with the device may not be securely carried.

### SUMMARY OF THE INVENTION

The present invention is advantageous in that a cradle with portability for a portable device is provided. Specifically, the present invention is advantageous in that a cradle capable of being carried along with a portable device housed therein is provided.

According to an aspect of the present invention, a portable cradle for housing a portable device therein is provided. The portable cradle for the portable device having at least one device-side terminal and a display panel for displaying images includes a housing portion, which houses therein the portable device with the display panel, the display panel being exposed from the housing portion, and covers the at least one device-side terminal when the portable device is inserted from one side of the housing portion, and a foldable base portion, which is provided at a side of the housing portion opposite of the side from which the portable device is inserted. The portable device housed in the cradle is supported by the base portion in an inclined position with the display panel facing in a predetermined direction. The housing portion includes at least one cradle-side terminal, the at least one cradle-side terminal being adapted to be connected to the at least one device-side terminal of the portable device. An internal circuit of the portable device is connected to an external device via the at least one cradle-side terminal and the at least one device-side terminal connected to the at least one cradle-side terminal.

Optionally, the portable cradle may include a locking system that is adapted to hold the portable device locked in the housing portion of the cradle when the portable device is inserted in the housing portion.

Optionally, one of the housing portion and the portable device may be provided with at least one line of groove along a direction in which the portable device is inserted into the cradle. The at least one line of the groove may have at least one in-groove projection. The other of the housing portion and the portable device may be provided with at least one protrusion that is adapted to engage with the at least one in-groove projection. The cradle may be adapted to hold the portable device locked in the housing portion when the at least one in-groove projection and the at least one protrusion are engaged with each other.

Optionally, the housing portion may be adapted to cover a lens equipped to the portable device.

According to an aspect of the present invention, a portable device that is adapted to be housed in a cradle, having at least one device-side terminal and a display panel for displaying images is provided. The cradle includes a housing portion for housing the portable device with the display panel therein, the display panel being exposed from the housing portion, the housing portion covering the at least one device-side terminal when the portable device is inserted from one side of the housing portion, and a foldable base portion, which is provided at a side of the housing portion opposite of the side from which the portable device is inserted. The portable device housed in the cradle is supported by the base portion in an inclined position with the display panel facing in a predetermined direction. The housing portion includes at least one cradle-side terminal, the at least one cradle-side terminal being adapted to be connected to the at least one device-side terminal of the portable device. An internal circuit of the portable device is connected to an external device via the at least one cradle-side terminal and the at least one device-side terminal connected to the at least one cradle-side terminal.

According to an aspect of the present invention, a digital camera that is adapted to be housed in a cradle, having at least one camera-side terminal and a display panel for displaying images is provided. The cradle includes a housing portion for housing the digital camera with the display panel therein, the display panel being exposed from the housing portion, the housing portion covering the at least one camera-side terminal when the digital camera is inserted from one side of the housing portion, and a foldable base portion, which is provided at a side of the housing portion opposite of the side from which the digital camera is inserted. The digital camera housed in the cradle is supported by the base portion in an inclined position with the display panel facing in a predetermined direction. The housing portion includes at least one cradle-side terminal, the at least one cradle-side terminal being adapted to be connected to the at least one camera-side terminal of the digital camera. An internal circuit of the digital camera is connected to an external device via the at least one cradle-side terminal and the at least one camera-side terminal connected to the at least one cradle-side terminal.

Optionally, the housing portion may be adapted to cover a photographing lens equipped to the digital camera.

### BRIEF DESCRIPTION OF THE DRAWINGS

FIGS. 1A-1D show plane views of a digital camera according to an embodiment of the invention.

FIG. 2 shows a cross-sectional view taken along a line II-II in FIG. 1C according to the embodiment of the invention.

FIGS. 3A-3C show plane views of a cradle for the digital camera according to the embodiment of the invention.

FIG. 4A shows a cross-sectional view of the cradle taken along a line IV-IV in FIG. 3A according to the embodiment of the invention, and FIG. 4B shows an enlarged cross-sectional view of a base portion of the cradle according to the embodiment of the invention.

FIGS. 5A and 5B show plane views of the cradle with the digital camera housed therein according to the embodiment of the invention.

FIGS. 6A-6C show cross-sectional side views of the cradle according to the embodiment of the invention.

FIG. 7A shows a cross-sectional side view of the cradle with the digital camera housed therein according to the embodiment of the invention, and FIG. 7B shows a front view of the cradle with the digital camera housed therein according to the embodiment of the invention.

### DETAILED DESCRIPTION OF THE EMBODIMENTS

Hereinafter, referring to the accompanying drawings, a cradle 10 for a portable device according to an illustrative embodiment of the invention will be described. The cradle 10 in the present embodiment of the invention is configured to house a digital camera 20 as a portable device therein. Firstly, a configuration of the digital camera 20 will be described, and subsequently a configuration of the cradle 10 according to the embodiment of the invention will be described.

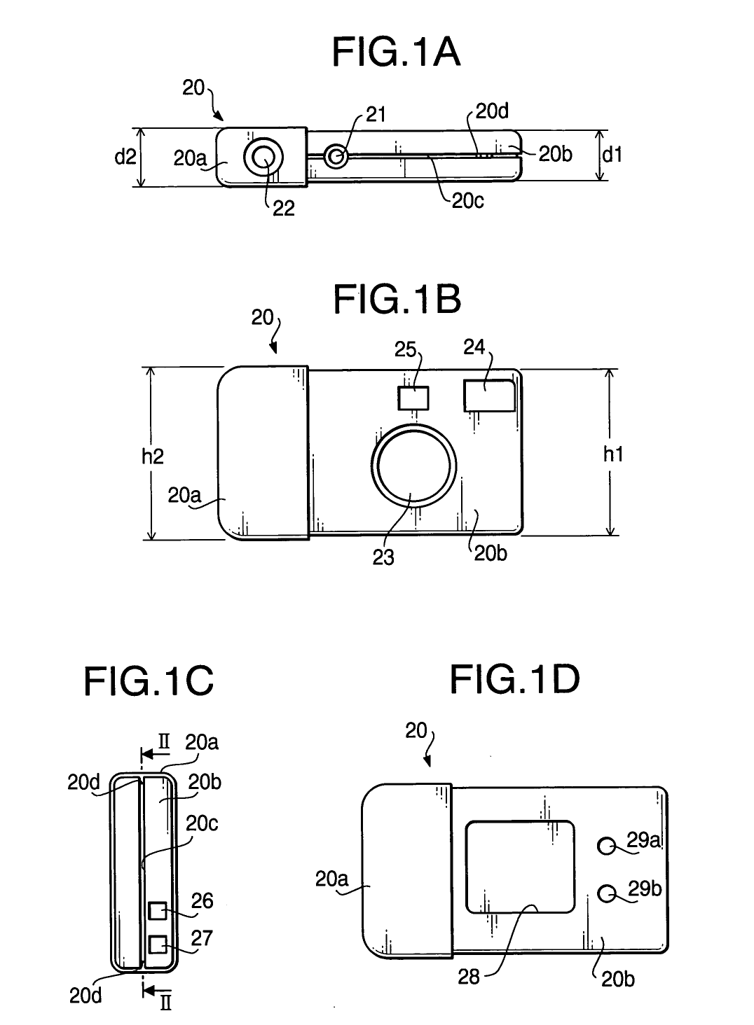

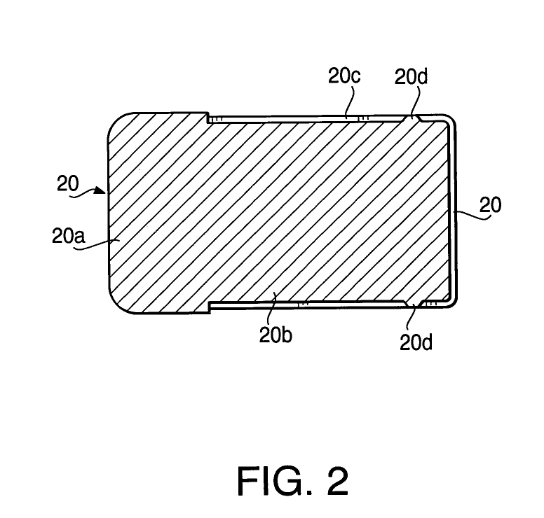

FIGS. 1A-1D show plane views of the digital camera 20 according to the embodiment of the invention. FIG. 1A shows a top plane view of the digital camera 20, FIG. 1B shows a front plane view of the digital camera 20, FIG. 1C shows a side plane view of the digital camera 20, and FIG. 1D shows a rear plane view of the digital camera 20 according to the embodiment of the invention. FIG. 2 shows a cross-sectional view of the digital camera 20 taken along a line II-II in FIG. 1C according to the embodiment of the invention (an internal structure of the digital camera 20 is omitted).

As shown in FIG. 1A, a top surface of the digital camera 20 is provided with a main switch button 21 that is pressed when the digital camera 20 is powered on and off, and a release button 22 that is pressed when an image of an object is photographed. On a front surface of the digital camera 20, as shown in FIG. B, a photographing lens 23, a strobe device 24, and a finder 25 are provided. Further, on a side surface of the digital camera 20, as shown in FIG. 1C, a USB (universal serial bus) interface 26 and a battery charge terminal 27 are provided. The USB interface 26 provides the digital camera 20 with a connection with an external device such as a PC (personal computer) to exchange data therebetween. The battery charge terminal 27 is connected to a battery (not shown) equipped inside the digital camera 20 so that the battery is charged via the battery charge terminal 27 and a feeding terminal, which will be explained hereinafter, by an external power source (not shown). It is to be noted that the USB interface 26 and the battery charge terminal 27 respectively serve as device-side terminals.

As shown in FIG. 1D, on a rear surface of the digital camera 20 is provided an LCD (liquid crystal display) panel 28. Further, a plurality of (in the present embodiment, two) operation setting buttons 29a, 29b, which are used for configuring operation settings of the digital camera 20, are provided in a vicinity to the LCD panel 28. It should be noted that a body of the digital camera 20 includes a grip portion 20a having the release button 22 and a main body 20b. A height h1 and a depth d1 of the main body 20b are formed to be substantially smaller than the height h2 and the depth d2 of the grip portion 20a. As shown in FIGS. 1A, 1C, and 2, a line of groove 20c is formed in a middle of the depth d1 to extend through the top surface, the side surface, and a bottom surface of the main body 20b. It should be noted that, as shown in FIG. 2, on the top surface and the bottom surface of the main body 20b, in-groove projections 20d, 20d with height thereof being substantially equal to a depth of the groove 20c are provided in the groove 20c at positions that vertically correspond to each other. The groove 20c and the in-groove projections 20d, 20d are configured to serve as a locking system that holds the digital camera 20 locked to the cradle 10 in the embodiment of the invention, which will be described hereinafter.

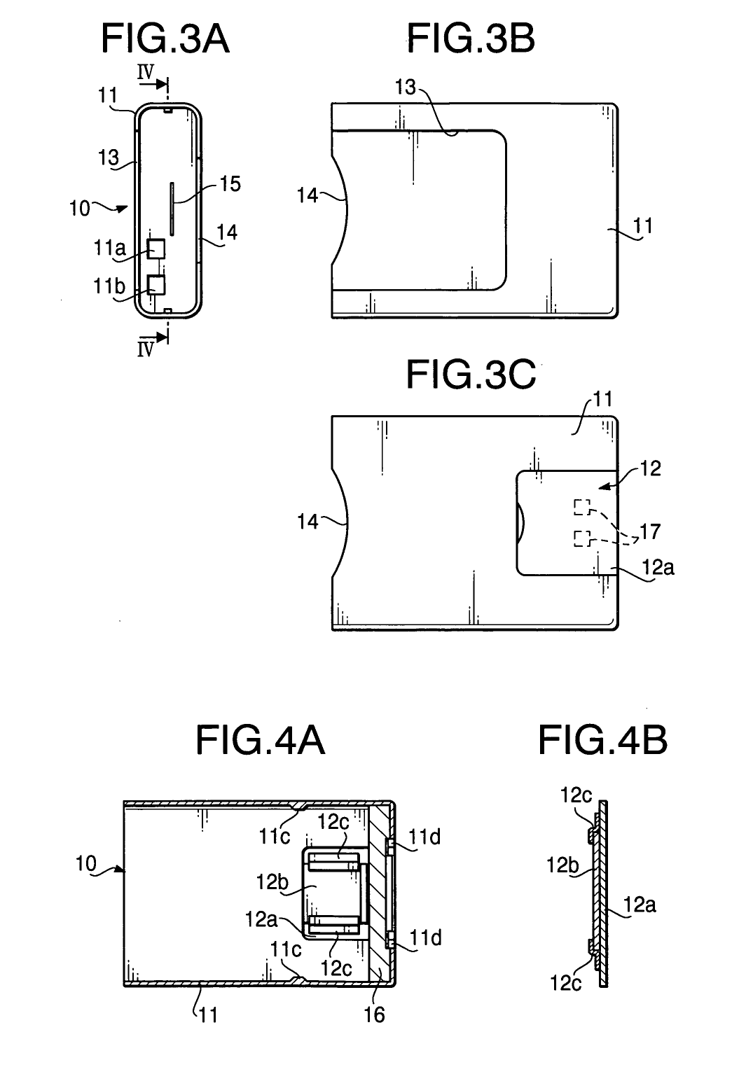

Next, a configuration of the cradle 10 that is portable along with the digital camera 20 being housed therein according to the illustrative embodiment of the invention will be described. FIG. 3A shows a side plane view of the cradle 10 taken along a direction in which the digital camera 20 is inserted according to the embodiment of the invention. FIG. 3B shows a front plane view of the cradle 10 taken from the left-hand side in FIG. 3A, and FIG. 3C shows a rear plane view of the cradle 10 taken from the right-hand side in FIG. 3A according to the embodiment of the invention. FIG. 4A shows a cross-sectional view of the cradle 10 taken along a line IV-IV in FIG. 3A, and FIG. 4B shows an enlarged cross-sectional view of a base portion of the cradle 10 according to the embodiment of the invention. Although, in the present embodiment, the surface of the digital camera 20 with the photographing lens 23 is referred to as the front surface, and the surface of the digital camera 20 with the LCD panel 28 is referred to as the rear surface, it should be noted that a surface of the cradle 10 that has a cutout for the LCD panel 28 to be exposed therefrom when the digital camera 20 is housed is referred to as the front surface, while a surface that covers the photographing lens 23 of the digital camera 20 is referred to as the rear surface.

As shown in FIGS. 3A-3C, the cradle 10 includes a housing portion 11, wherein the digital camera 20 is housed and the device-side terminals including the USB interface 26 and the battery charge terminal 27 are covered when the digital camera 20 is housed, and a base portion 12, which is equipped on the rear surface of the cradle 10. On the front surface of the cradle 10 is formed an approximate rectangle-shaped front cutout 13, which is adapted to expose the LCD panel 28 therethrough when the digital camera 20 is housed in the cradle 10, while an arc-shaped rear cutout 14, which helps a user to pull the digital camera 20 out of the cradle 10, is formed on the rear surface.

As shown in FIGS. 4A and 4B, the base portion 12 includes a stand plate 12a, which is coupled with a right-hand end of the cradle 10 (i.e., a lower edge when the cradle 10 is settled in a standing position) via hinges 11d and is angularly movable about the hinges 11d (i.e., a rotation axis). The base portion 12 further includes a slider plate 12b, which is equipped inside the stand plate 12a, although the slider plate 12b comes on top of the stand plate 12a when the cradle 10 is in the standing position. The slider plate 12b is adapted to be guided in between guide plates 12c, 12c, each of which is formed to have a cross-sectional surface of a cranked shape and is fixed to the stand plate 12b. Thus the slider plate 12b is slidable in parallel with the stand plate 12b, which is in a direction perpendicular to the rotation axis.

As shown in FIGS. 3A and 4A, on an inner top surface and on an inner bottom surface of the housing portion 11, inner protrusions 11c, 11c are respectively formed. The inner protrusions 11c, 11c are formed in positions wherein the in-groove projections 20d, 20d are overcome by the inner protrusions 11c, 11c when the digital camera 20 is properly housed in the housing portion 11 of the cradle 10, so that the in-groove projections 20d, 20d and the inner protrusions 11c, 11c are engaged to sustain the digital camera 20 locked in the cradle 10. Thus, the inner protrusions 11c, 11c of the cradle 10, the groove 20 and the in-groove projections 20d, 20d are configured to serve as the locking system.

On an inner bottom surface (i.e., an inner bottom surface of the cradle 10 when the cradle 10 is in the standing position) of the housing portion 11, a feeding terminal 11a and a data I/O (input/output) interface 11b are provided, as shown in FIG. 3A. The feeding terminal 11a is adapted to be connected to the battery charge terminal 27 when the digital camera 20 is properly housed in the cradle 10 so that the battery equipped inside the digital camera 20 is charged by the external power source. The data I/O interface 11b is adapted be connected to the USB interface 26 of the digital camera 20, so that data is exchanged between the digital camera 20 and an external device such as a PC. The feeding terminal 11a and the data I/O interface 11b are configured to serve as cradle-side terminals. In a vicinity to a center of the inner bottom surface is provided a stopper 15, with which the slider plate 12b is in contact when the base portion 12 is extended and the cradle 10 is in the standing position.

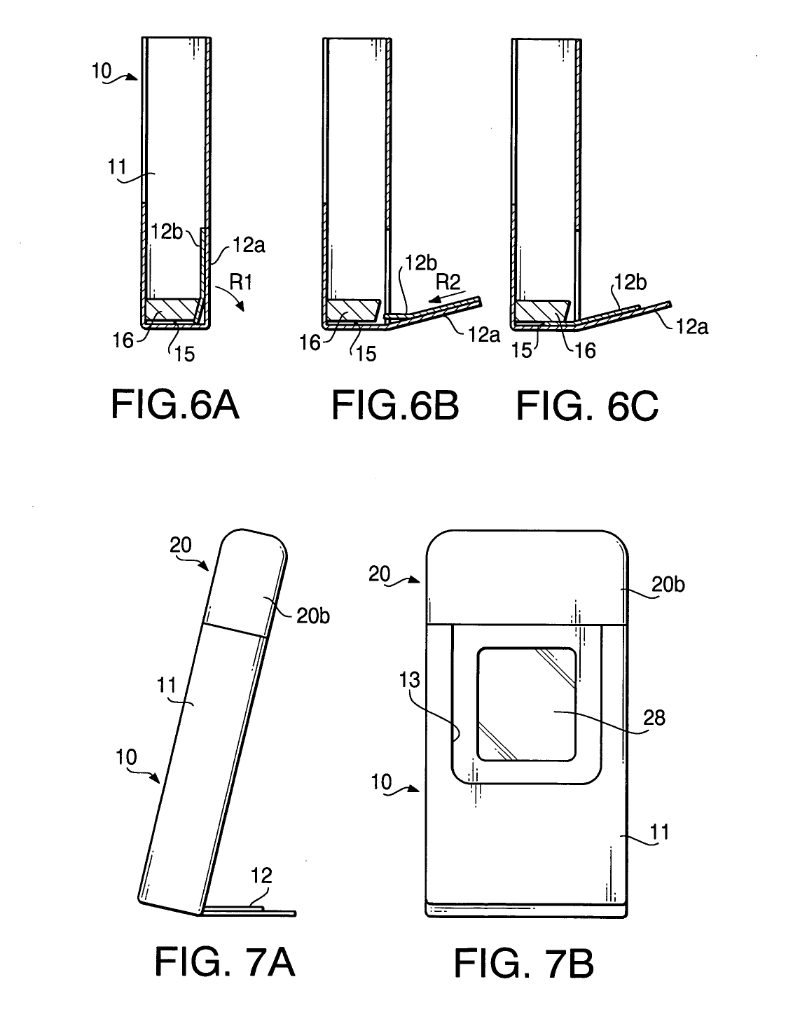

The feeding terminal 11a is connected to a power connector pair 17 via an electric circuit equipped in a substrate unit 16 (see FIGS. 6A-6C). When the power connector pair 17 is connected to the external power source, the battery of the digital camera 20 is connected to and thereby charged with the external power source via the feeding terminal 11a and the battery charge terminal 27. The power connector pair 17 is arranged on a rear surface of the substrate unit 16, so that the power connector pair 17 is exposed when the base portion 12 (i.e., the stand plate 12a and the slider plate 12b) is extended outwardly to have the cradle 10 in the standing position, while the power connector pair 17 is covered with the base portion 12 that is in a folded position. Therefore, it should be noted that the base portion 12 is configured to also serve as a cover for the power connector pair 17.

The data I/O interface 11b is connected to a USB connector (not shown). A cable (not shown) connected to the external PC on one end is connected to the USB connecter at the other end, and thus the digital camera 20 is connected to the PC. When data management software that has been previously installed in the PC is activated, data stored in a memory device (not shown) of the digital camera 20 can be exchanged with the PC and vice versa via the data I/O interface 11b and the USB interface 26.

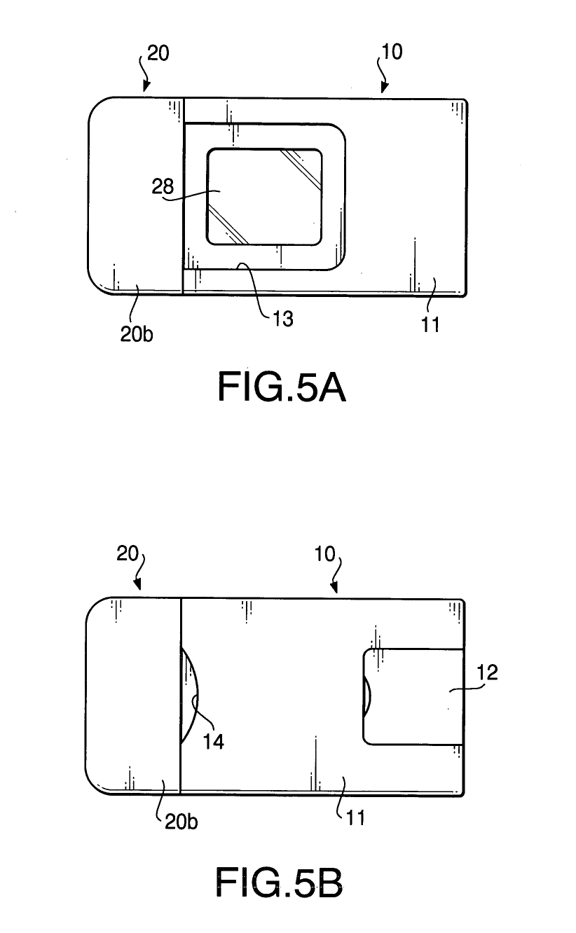

Next, a configuration of the cradle 10 when in use according to the embodiment of the invention will be described. FIGS. 5A and 5B show plane views of the cradle 10 with the digital camera 20 housed therein according to the embodiment of the invention. As shown in FIGS. 5A and 5B, when the digital camera 20 is housed in the cradle 10, the main body 20b of the digital camera 20 is inserted into the housing portion 11 of the cradle until the digital camera 20 is locked in the cradle 10 by the above-described locking system. Thus, the digital camera 20 is housed in the cradle 10 with the grip portion 20a being exposed. With this structure, some components of the digital camera 20 including the device-side terminals 26, 27, the photographing lens 23, the strobe device 24, and the finder 25 are covered with the housing portion 11 of the cradle 10, while the LCD panel 28 is exposed through the front cutout 13, so that images shown on the LCD panel 28 can be viewed even when the digital camera 20 is housed in the cradle 10. As shown in FIG. 5B, the base portion 12 is in the folded position with the stand plate 12a and the slider plate 12b being folded against the rear surface of the housing portion 11. In this position, the power connector pair 17 is covered with the base portion 12b and thereby protected.

FIGS. 6A-6C show cross-sectional side views of the cradle 10 when in use according to the embodiment of the invention. When the cradle 10 with the digital camera 20 is settled on a flat surface, for example a desktop, the base portion 12 is extended in a sequence as shown in FIGS. 6A through 6C. Firstly, the stand plate 12a along with the slider plate 12b in the folded position is pulled out by the user from the housing portion 11, and is rotated about the lower edge of the cradle 10 where the stand plate 12b is coupled to in a direction indicated by an arrow R1 (see FIG. 6A). Secondly, when the stand plate 12a and the slider plate 12b are rotated to an extent, for example as shown in FIG. 6B, the slider plate 12b is slid in a direction indicated by an arrow R2. It should be noted that the slider plate 12b is bent at an angle along a line that is in parallel with the lower edge of the cradle 10, and a bent portion (i.e., a portion that is floating from the stand plate 12a) is inserted underneath the substrate unit 16. Then, when the inserted bent portion comes in contact with the stopper 15 (see FIG. 6C), the bent portion is stopped thereat and remains angled with respect to the rear surface of the housing portion 11.

FIG. 7A shows a cross-sectional side view of the cradle 10 with the digital camera 20 housed therein, and FIG. 7B shows a front view of the cradle 10 with the digital camera 20 housed therein according to the embodiment of the invention. When the cradle 10 with the digital camera 20 housed therein is settled on the flat surface with the base portion 12 extended and the stand plate 12a being in contact with the flat surface as described above, the housing portion 12 supported by the base portion 12 is inclined at the bent angle of the slider plate 12b. In this position, as shown in FIG. 7A, the digital camera 20 can be held inclined with respect to the flat surface on which the cradle 10 is settled, with the LCD panel 28 of the digital camera 20 facing obliquely upward so that the user can easily view the images shown on the LCD panel 28. Further, in this position, the digital camera 20 is connected to the external power source via the power connector pair 17 of the cradle 10 so that the battery of the digital camera 20 can be charged. Furthermore, the digital camera 20 is connected to the PC via the USB cable that is connected to the USB connector, so that the data stored in the memory device of the digital camera 20 can be exchanged with the PC and vice versa.

With the above-described configuration, the cradle 10 can serve as a protection case of the digital camera 20 when the digital camera 20 is carried in the cradle 10. Further, the cradle 10 holding the digital camera 20 therein enables charging the battery of the digital camera 20 and exchanging data between the digital camera 20 and other external devices. Furthermore, the LCD panel 28 of the digital camera 20 being faced obliquely upward helps the user to easily view the images shown on the LCD panel 28.

The present disclosure relates to the subject matter contained in Japanese Patent Application No. 2005-081948, filed on Mar. 22, 2005, which is expressly incorporated herein by reference in its entirety.

What is claimed is:

1. A portable cradle for housing a portable device therein, the portable device having at least one device-side terminal and a display panel for displaying images, comprising:
a housing portion, which houses therein the portable device with the display panel, the display panel being exposed from the housing portion, and covers the at least one device-side terminal when the portable device is inserted from one side of the housing portion, and
a foldable base portion, which is provided at a side of the housing portion opposite of the side from which the portable device is inserted, wherein the portable device housed in the cradle is supported by the base portion in an inclined position with the display panel facing in a predetermined direction,
wherein the housing portion includes at least one cradle-side terminal, the at least one cradle-side terminal being adapted to be connected to the at least one device-side terminal of the portable device, and
wherein an internal circuit of the portable device is connected to an external device via the at least one cradle-side terminal and the at least one device-side terminal connected to the at least one cradle-side terminal.

2. The portable cradle according to claim 1, comprising a locking system that is adapted to hold the portable device locked in the housing portion of the cradle when the portable device is inserted in the housing portion.

3. The portable cradle according to claim 2,
wherein one of the housing portion and the portable device is provided with at least one line of groove along a direction in which the portable device is inserted into the cradle, the at least one line of the groove having at least one in-groove projection,
wherein the other of the housing portion and the portable device is provided with at least one protrusion that is adapted to engage with the at least one in-groove projection, and
wherein the cradle is adapted to hold the portable device locked in the housing portion when the at least one in-groove projection and the at least one protrusion are engaged with each other.

4. The portable cradle according to claim 1, wherein the housing portion is adapted to cover a lens equipped to the portable device.

5. A portable device that is adapted to be housed in a cradle, comprising at least one device-side terminal and a display panel for displaying images,
wherein the cradle includes a housing portion for housing the portable device with the display panel therein, the display panel being exposed from the housing portion, the housing portion covering the at least one device-side terminal when the portable device is inserted from one side of the housing portion, and a foldable base portion, which is provided at a side of the housing portion opposite of the side from which the portable device is inserted,
wherein the portable device housed in the cradle is supported by the base portion in an inclined position with the display panel facing in a predetermined direction,
wherein the housing portion includes at least one cradle-side terminal, the at least one cradle-side terminal being adapted to be connected to the at least one device-side terminal of the portable device, and
wherein an internal circuit of the portable device is connected to an external device via the at least one cradle-side terminal and the at least one device-side terminal connected to the at least one cradle-side terminal.

6. The portable device according to claim 5, wherein the cradle includes a locking system that is adapted to hold the portable device locked in the housing portion of the cradle when the portable device is inserted in the housing portion.

7. The portable device according to claim 6,
wherein one of the housing portion and the portable device is provided with at least one line of groove along a direction in which the portable device is inserted into the cradle, the at least one line of the groove having at least one in-groove projection,
wherein the other of the housing portion and the portable device is provided with at least one protrusion that is adapted to engage with the at least one in-groove projection, and
wherein the cradle is adapted to hold the portable device locked in the housing portion when the at least one in-groove projection and the at least one protrusion are engaged with each other.

8. The portable device according to claim 5, wherein the housing portion is adapted to cover a lens equipped to the portable device.

9. A digital camera that is adapted to be housed in a cradle, comprising at least one camera-side terminal and a display panel for displaying images,
wherein the cradle includes a housing portion for housing the digital camera with the display panel therein, the display panel being exposed from the housing portion, the housing portion covering the at least one camera-side terminal when the digital camera is inserted from one side of the housing portion, and a foldable base portion, which is provided at a side of the housing portion opposite of the side from which the digital camera is inserted,
wherein the digital camera housed in the cradle is supported by the base portion in an inclined position with the display panel facing in a predetermined direction,
wherein the housing portion includes at least one cradle-side terminal, the at least one cradle-side terminal being adapted to be connected to the at least one camera-side terminal of the digital camera, and
wherein an internal circuit of the digital camera is connected to an external device via the at least one cradle-side terminal and the at least one camera-side terminal connected to the at least one cradle-side terminal.

10. The digital camera according to claim 9, wherein the cradle includes a locking system that is adapted to hold the digital camera locked in the housing portion of the cradle when the digital camera is inserted in the housing portion.

11. The digital camera according to claim 10,
wherein one of the housing portion and the digital camera is provided with at least one line of groove along a direction in which the digital camera is inserted into the cradle, the at least one line of the groove having at least one in-groove projection,
wherein the other of the housing portion and the digital camera is provided with at least one protrusion that is adapted to engage with the at least one in-groove projection, and
wherein the cradle is adapted to hold the digital camera locked in the housing portion when the at least one in-groove projection and the at least one protrusion are engaged with each other.

12. The digital camera according to claim 9, wherein the housing portion is adapted to cover a photographing lens equipped to the digital camera.
